(19) United States
(12) Patent Application Publication
(10) Pub. No.: US 2003/0092297 A1
(43) Pub. Date: May 15, 2003

(54) Convenience light with supplemental electrical outlet

(75) Inventors: Mark E. Reindle, Sagamore Hills, OH (US); Jonathan Katz, Solon, OH (US); Kristin M. Nichols, Cleveland Hts., OH (US); Craig M. Saunders, Rocky River, OH (US); Donald C. Fuchs JR., Mentor, OH (US)

Correspondence Address: Jay F. Moldovanyi, Esq., Fay, Sharpe, Fagan, Minnich & McKee, LLP, 7th Floor, 1100 Superior Avenue, Cleveland, OH, 44114-2518, US

(73) Assignee: Royal Appliance Mfg. Co.

(21) Appl. No.: 10/292,645

(22) Filed: Nov. 12, 2002

Related U.S. Application Data
(60) Provisional application No. 60/337,630, filed on Nov. 12, 2001.

(51) Int. Cl. H01R 4/66

(52) U.S. Cl. 439/107

(57) ABSTRACT

A convenience light with a supplemental electrical outlet is provided. In one embodiment, the apparatus includes a housing, a first light source to emit light when the apparatus is coupled to a conventional electrical outlet, and a supplemental electrical outlet having at least the same amount of electrical receptacles as the conventional electrical outlet to which the apparatus is coupled. In another embodiment, the first light source selectively emits light and the apparatus also includes a control device to control when the light source emits light. In yet another embodiment, the supplemental electrical outlet selectively provides access to electrical power associated with the conventional electrical outlet and the apparatus also includes a control device to control when the supplemental electrical outlet provides access to the electrical power.

This application claims the priority of U.S. application Serial No. 60/337,630, filed Nov. 12, 2001.

### BACKGROUND OF INVENTION

The invention relates to a convenience light with a supplemental electrical outlet. It finds particular application in conjunction with a device or apparatus for providing convenient lighting functions along with a supplemental electrical outlet and will be described with particular reference thereto However, it is to be appreciated that the invention is also amenable to other applications For example, additional functions may be provided in combination with the lighting function and supplemental electrical outlet.

In the past night lights have been used to provide illumination for safety, comfort, security and the like, for example, at night after the main lights have been extinguished. A typical night light has a plastic base, a small lamp socket, a lamp in the socket, and plug type prongs or terminals that plug into an electrical socket or outlet (sometimes referred to as a “convenience outlet.” Several problems exist with such night lights, especially when small children are involved A child may reach for an illuminated lamp as a point of interest and may burn fingers; the child may break off the lamp from the lamp base exposing sharp glass edges that could cause injury; or the child may insert a finger into a lamp socket either after having unscrewed the lamp or having broken the lamp from the lamp base.

Accordingly, there is a need for supplemental lighting that has enhanced safety features for use, for example, in circumstances when main lights in an area are extinguished that provides some safety improvement.

Various devices that plug into a conventional electrical outlet and provide respective functions have been developed over the years. Several examples include extension cords, air fresheners, low voltage transformers for electrical or electronic appliances and rechargeable flashlights that come on automatically in the event the wall socket power is interrupted These devices may be difficult to find in a dark room and may lead to accidents.

Also, such devices need to occupy a wall socket, such as one socket of a duplex electrical outlet, which makes that socket unavailable for other purposes.

### BRIEF SUMMARY OF INVENTION

Thus, there is a particular need for improving the availability of electrical outlets associated with convenience lights and other special features associated therewith. The invention contemplates a convenience light and an associated electrical receptacle that overcomes at least one of the above-mentioned problems and others.

In one embodiment of the invention, an apparatus for insertion in a conventional electrical outlet having one or more electrical receptacles is provided. The apparatus includes a housing, a first light source disposed within the housing to emit light from the apparatus when the apparatus is inserted in the conventional electrical outlet, and a supplemental electrical outlet disposed within the housing and having at least the same amount of electrical receptacles as the conventional electrical outlet to provide access to electrical power associated with the conventional electrical outlet when the apparatus is inserted therein. Typically, the apparatus is referred to as a convenience light with a supplemental electrical outlet.

In another embodiment, the apparatus includes a housing, a first light source disposed within the housing to selectively emit light from the apparatus when the apparatus is inserted in the conventional electrical outlet, a supplemental electrical outlet disposed within the housing and having at least the same amount of electrical receptacles as the conventional electrical outlet to provide access to electrical power associated with the conventional electrical outlet when the apparatus is inserted therein, and a control device to control when the light source emits light.

In yet another embodiment, the apparatus includes a housing, a first light source disposed within the housing to emit light from the apparatus when the apparatus is inserted in the conventional electrical outlet, a supplemental electrical outlet disposed within the housing and having at least the same amount of electrical receptacles as the conventional electrical outlet to selectively provide access to electrical power associated with the conventional electrical outlet when the apparatus is inserted therein, and a control device to control when the supplemental electrical outlet provides access to the electrical power.

A benefit associated with the invention is that a convenience light for insertion in a conventional electrical outlet having one or more electrical receptacles includes a supplemental electrical outlet having at least as many electrical receptacles as the conventional electrical outlet to which the convenience light is coupled.

Additional benefits and advantages of the invention will become apparent to those of ordinary skill in the art upon reading and understanding the description of the invention provided herein.

### BRIEF DESCRIPTION OF DRAWINGS

The invention is described in more detail in conjunction with a set of accompanying drawings. Within the drawings, like reference numerals denote like elements.

FIG. 1 is a first embodiment of a convenience light device according to the present invention shown in an exploded isometric view.

FIG. 2 is a second embodiment of a convenience light device according to the present invention shown in an exploded isometric view and shown in relation to a conventional duplex electrical outlet.

FIG. 3 is an isometric view of an embodiment of a voice activated convenience light device according to the present invention.

FIG. 4 is a block diagram of the voice activated convenience light of FIG. 3.

FIG. 5 is an isometric view of an embodiment of a convenience light with a security device according to the present invention.

FIG. 6 is a block diagram of the convenience light and security device of FIG. 5.

FIG. 7 is an isometric view of an embodiment of a convenience light with multiple supplemental electrical outlets and built-in surge suppression according to the present invention.

FIGS. 8A and 8B are isometric views of an embodiment of a convenience light according to the present invention with a removable flashlight portion.

FIG. 9 is a block diagram of the convenience light and flashlight portion of FIGS. 8A and 8B.

FIG. 10 is an isometric view of an embodiment of the present invention including a convenience light with a deodorizer.

FIG. 11 is an isometric view of an embodiment of the present invention including a convenience light with an internal battery for emergency lighting during power failures.

FIG. 12 is a block diagram of the convenience light and internal battery of FIG. 11.

FIG. 13 is an isometric view of an embodiment of the present invention having a convenience light with an extension cord and an internal reel storage mechanism.

FIG. 14 is an isometric view of an embodiment of a convenience light with a light director according to the present invention.

FIGS. 15A-D are isometric views of embodiments of convenience lights with respective arrangements for minimal intensity, normal intensity, full intensity and diff-used intensity control features according to the present invention

FIG. 16 is an isometric view of an embodiment of the present invention having a convenience light with pass-through controls to test and reset a ground fault circuit interrupter (GFCI) electrical outlet to which the light is coupled

FIG. 17 is an isometric view of an embodiment of the present invention having a convenience light with pass-through controls to operate a toggle switch and to test and reset a GFCI electrical outlet to which the light is coupled.

FIG. 18 is an isometric view of an embodiment of a convenience light with a glowing cover according to the present invention.

FIGS. 19A and 19B are isometric views of an embodiment of the present invention including a convenience light with a light sensor respectively during lighted and dark conditions.

FIG. 20 is a block diagram of the convenience light and light sensor of FIGS. 19A and 19B.

FIG. 21 is an isometric view of an embodiment of the present invention having a convenience light with multiple side-access receptacles and surge suppression.

FIG. 22 is an isometric view of an embodiment of the present invention including a convenience light with a timer to control a supplemental electrical outlet associated with the convenience light.

### DETAILED DESCRIPTION

While the invention is described in conjunction with the accompanying drawings, the drawings are for purposes of illustrating exemplary embodiments of the invention and are not to be construed as limiting the invention to such embodiments It is understood that the invention may take form in various components and arrangement of components and in various steps and arrangement of steps beyond those provided in the drawings and associated description. In particular, it will be appreciated that a feature of one or more embodiments described herein may be used with other embodiments.

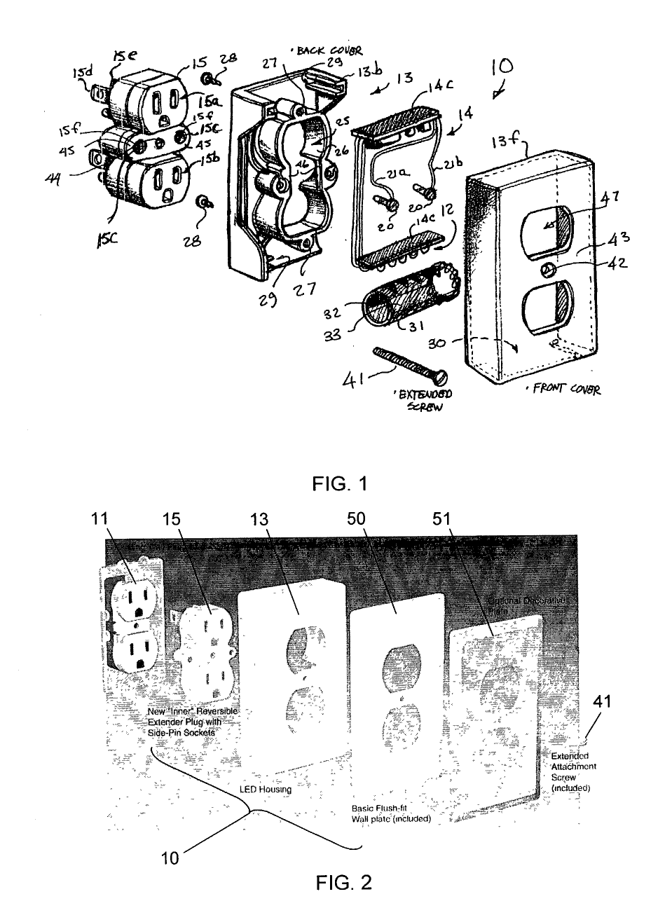

Referring, now, to the drawings, wherein like reference numerals refer to like parts in the several figures, and initially to FIGS. 1 and 2, a convenience light is generally illustrated at 10 in alignment to plug into a conventional electrical outlet, duplex receptacle, or the like 11. Typically, the conventional electrical outlet 11 is a duplex outlet (i.e., two electrical outlets) with each outlet capable of receiving an electrical plug to connect electrical power (e.g., 110 VAC, 220 VAC, or the like) to an electrical device. However, other combinations of outlets, for example, single outlets or three or more outlets, are also contemplated. Typically, the duplex outlet is a residential type with a 5-15R socket configuration, as is commonly used in US homes. However, other standard U.S. types, such as commercial and industrial outlets, are also contemplated. Other standard U.S. electrical outlet types such as decora outlets (i.e., two outlets arranged on a single raised rectangular surface) and ground fault circuit interrupt (GFCI) outlets. Likewise, other standard U.S socket configurations, such as 5-20R, L5-15R, and L6-20R, are also contemplated Additionally, similar standard international and national outlet types and socket configurations are contemplated.

As is illustrated in FIG. 1, the convenience light 10 includes a light source 12, a housing 13, circuitry 14, and a supplemental electrical outlet 15 The supplemental electrical outlet 15 can be plugged directly into the conventional electrical outlet 11. The supplemental electrical outlet 15 includes at least the same amount of electrical outlets as the conventional electrical outlet 11. For example, as shown, the convenience light 10 plugs into a conventional duplex outlet 11 and the supplemental electrical outlet 15 provides two respective sockets 15a, 15b to which electrical plugs or the like associated with electrical devices can be electrically connected. The supplemental electrical outlet 15 also includes male electrical terminals 15d, 15e that plug into respective sockets in the conventional electrical outlet 11. The configuration of the male electrical terminals 15d, 15e matches the socket configuration of the supplemental electrical outlets 15a, 15b Note that, as shown, the socket configuration of the supplemental electrical outlets 15a, 15b also matches the socket configuration of the conventional duplex outlet 11 However, as is known in the art, often socket configurations for 15 amp plugs can be plugged in to 20 amp outlets. Hence, it is possible for a convenience light 10 with 15 amp supplemental electrical outlets (e.g., 5-15R) to be plugged in to a conventional duplex outlet 11 with 20 amp outlets (e.g., 5-20R), but not vice versa.

The supplemental electrical outlet 15 also includes internal terminals 15c, for example, that electrically connect with the respective male terminals 15d, 15e. Such internal terminals 15c are in respective openings 15f of the housing 15g of the supplemental electrical outlet 15. The terminals 15c are accessible to pin terminals 20 that may be inserted into the openings 15f to make respective electrical connections therebetween. Moreover, the pin terminals 20 are connected to electrical wires 21a, 21b, leads or the like, or which may be printed electrically conductive traces or the like, or some other electrical connection arrangement, to provide electrical power to the circuitry 14 to operate the light source 12 and/or one or more other devices associated therewith, including the supplemental electrical outlet 15

The light source 12 may be one or more light emitting diodes (LED), organic light emitting diodes (OLED), electroluminescent devices (ELD), or some other light sources. An advantage to using OLED is that they are relatively low power and relatively high efficiency for the light provided when lit. As illustrated, the light source 12 includes five OLED devices, but it will be appreciated that the invention may include more or fewer devices.

The circuitry 14 may include control circuitry, voltage step down circuitry, rectifier circuitry, and/or other devices useful to suitably regulate the power to the light source 12. The circuitry may be powered directly by electrical power from the electrical wires 21a, 21b, or, as is described below, the circuitry 14 may be powered by a battery backup device The circuitry may provide power to the light source 12 or may control power to the light source 12, as may be desired. The circuitry 14 may also control application of power to the supplemental electrical outlets 15.

The housing 13 includes a back cover 13b and a front cover 13f. The housing 13 may be made of plastic or of some other suitable material, such as the material of which the housing for the conventional electrical outlet 11 is made or some other material. The back cover 13b has adequate space 25 and guiding walls 26 to receive and to mount therein the supplemental electrical outlet 15. Openings 27 and screws 28 may be provided to fasten the back cover 13b to respective openings (not shown) in the front cover 13f. Slotted walls 29 in the back cover are provided to receive and to retain respective circuit boards 14c in the cover 13

The bottom 30 of the housing 13 may be open and a rotatable generally cylindrical insert 31 may be inserted in the area of such opening 30. The insert 31 may have some solid wall portions 32 and some open areas 33. The solid wall portions 32 may block light transmission by the light source 12 out from the bottom of the housing 13. The solid wall portions 32 may include light diffusing material that diffuses part or all of the light that is transmitted therethrough from the light source 12. The solid wall portion 32 may include a light attenuator to transmit light from the light source 12 but at a reduced intensity. The open areas 33 may allow direct light transmission out of the housing 13 without diffusion, attenuation, or blocking. A suitable conventional support, such as a generally cylindrical wall or boss (not shown), e.g., molded as part of the back cover 13b or otherwise formed or provided, may be used to mount the insert 31 in the housing.

The convenience light 10 may be assembled, for example, as follows. The supplemental electrical outlet 15 is inserted into the space provided in the back cover 13b The pin terminals 20 are inserted into the openings 15f in the back cover 13b and through into the openings in the supplemental electrical outlet 15 to engage and to electrically connect with the terminals 15c therein. The circuit boards 14c are placed in the guides provided in the back cover (the light source 12 may be mounted on one of those circuit boards); and the cylindrical insert 31 is placed relative to the back cover and light source. The front cover 13f and back cover 13b are placed in aligned relation to each other such that the respective side walls of each fit in relatively close proximity to each other; and a screw 41 inserted through an opening 42 in the front wall 43 of the front cover 13f is threaded into a threaded opening 44 in the supplemental electrical outlet 15 to connect the front cover to the supplemental socket 15 holding it and the back cover 13b together with the front cover 13f. The ear-like areas 45 of the supplemental electrical outlet 15 and stop walls 46 of the back cover 13b cooperate with each other to allow the tightening of the screw 41 to secure the portions of the convenience light 10 together.

Advantageously, using the convenience light 10 the sockets 15a, 15b are available or exposed in openings 47 in the front wall 43 of the front cover 13f so that plugs may be inserted into such sockets for electrical connection to the respective sockets of the conventional electrical outlet 11. There is no need for a separate electrical wiring, e.g., hard wiring, of the convenience light 10 to a power source. Moreover, there are no electric lamps that can be unscrewed to expose a lamp socket, nor is there an electric lamp that can be broken from its base. Further, there is no reduction in the number of electrical outlets available for use, while the lighting function provided by the light source 12 of the convenience light 10 provides desired light output function. Also, if desired, the cylindrical insert 31 may be operated to control the nature of the light output from the convenience light 10 As is illustrated in FIG. 2, various cover plates 50 or 51 may be secured to the housing 13 by the screw 41 for aesthetics and/or to provide protection for the housing 13.

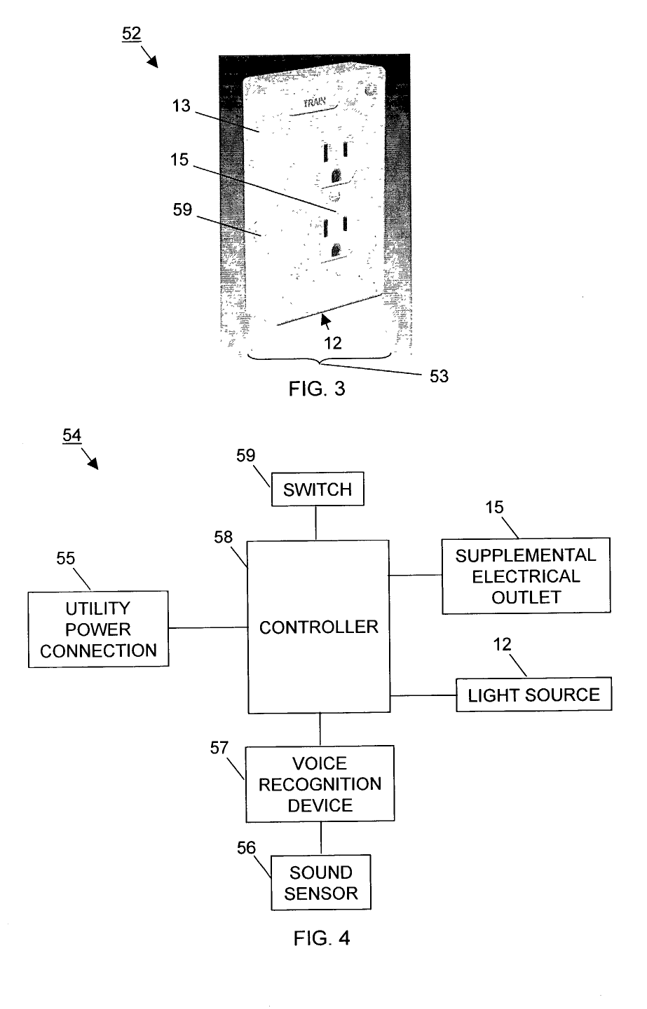

FIG. 3 shows another embodiment of a convenience light 52. In this embodiment, the convenience light 52 is similar to the embodiments described above and includes a light source 12, a housing 13, a supplemental electrical outlet 15, and a switch 59. This embodiment of the convenience light 52 provides voice-activated control features. More specifically, as is illustrated schematically in FIG. 4, the circuitry 14 (FIG. 1) may include a circuit 54 that is voice-activated to control operation of the light source 12 and/or the supplemental electrical outlet 15 The circuit 54 includes a utility power connection 55, e.g., connection with a duplex receptacle such as that shown at 11, a sound sensor 56, a voice recognition device 57, a controller 58, and a switch 59. The switch 59 is an optional component for control of the light source 12 and has at least two positions (e.g., on and normal). If the switch 59 is in the on position, the controller 58 will illuminate the light source 12. If the switch 59 is in the normal position, the light source 12 will be controlled using the voice activated controls. In another configuration (not illustrated), a three-position switch includes a third position (e.g., off) in which control of the light source 12 is effectively disabled.

The sound sensor 56 may include a microphone. The voice recognition device 57 may be of the type sold by VST of Boston, Mass. Other known voice recognition software may also be used, such as is sold under the name Dragon Software. In operation of the circuit 54, the sound sensor 56 detects an incoming sound; the voice recognition device 57 decodes the detected sound and determines whether the sound is a particular command, such as a command to turn on the light source 12, to turn off the light source 12, to adjust the level or intensity of the light output 53 from the light source 12, to apply electrical power to the supplemental electrical outlet 15 and/or to remove electrical power from the supplemental electrical outlet 15. The level or intensity of the light output 53 may be controlled, for example, by independently controlling one or more of the multiple light-emitting devices associated with the light source 12. The output from the voice recognition device 57 operates the controller 58 to effect the appropriate controlled operation (i.e., illumination of the light source 12 and/or control of the supplemental electrical outlet 15). The controller 58 includes switch devices with input and output power connections and control connections to open and close the electrical power to the supplemental electrical outlet 15.

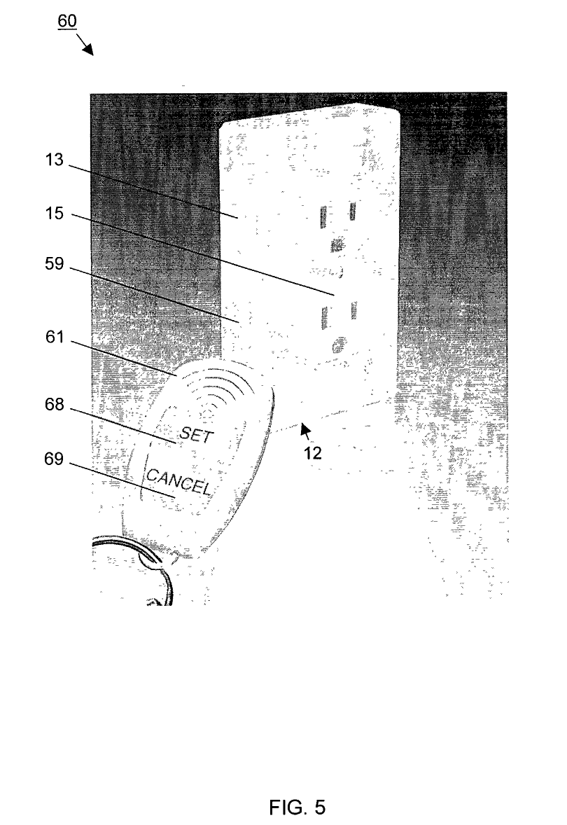

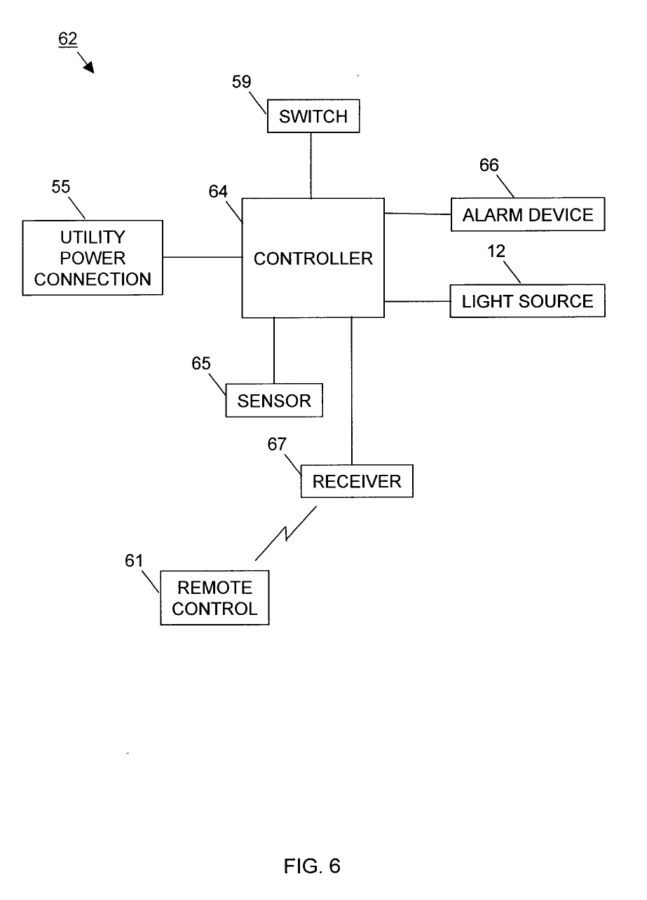

FIG. 5 shows another embodiment of a convenience light 60. In this embodiment, the convenience light 60 is similar to the embodiments described above and includes a light source 12, a housing 13, a supplemental electrical outlet 15, a switch 59, and a remote control 61. Additionally, within the housing 13, the convenience light 60 includes a sensor 65 (FIG. 6) for detecting motion, heat, smoke, carbon monoxide, or some other detectable input. In response to such detection, the circuitry 14 (FIG. 1) flashes the light source 12 and sounds an audible alarm device 66 (FIG. 6). In another embodiment, another type of alarm device may be used in combination with the light source when an alarm condition is detected. Moreover, the alarm device 66 and the light source 12 may be used independently when an alarm condition is detected. The type of flashing and/or the sound emitted when an alarm condition is detected may be varied depending on various types of alarm conditions, particularly when multiple types of sensors 65 (e.g., motion, carbon monoxide) are provided. The remote control 61 is optional and includes a set button 68 and a cancel button 69. Pressing the set button 68 manually causes the convenience light 60 to enter into an alarm condition. For the manual alarm condition, pressing the cancel button 69 removes the alarm condition, silences audible alarms, and stops the flashing of the light source 12. For other types of alarm conditions, pressing the cancel button 69 silences any audible alarms triggered by sensors 65, while the light source 12 continues to flash as long as the sensor 65 continues to indicate that the alarm condition exists. Alternate remote control configurations are also contemplated, as well as alternate control schemes.

In FIG. 6 a circuit 62 associated with the convenience light 60 is illustrated. The circuit 62 includes a utility power connection 55, a switch 59, a controller 64, a sensor 65 (e.g., motion sensor, smoke detector), a light source 12, an alarm device 66, a receiver 67, and a remote control 61. The remote control 61 controls the convenience light 60 via communications to the receiver 67. The controller 64 receives control signals from the receiver 67, switch 59, and sensor 65. The controller 64 controls operation of the light source 12 in response to power at the utility power connection 55 and input signals from the switch 59, detector 65, and remote control 61. The controller 64 also controls operation of the alarm device 66.

The switch 59 works as described above in conjunction with FIG. 4. If the switch 59 is set to the normal position and, for example, motion is detected by the sensor 65, the controller 64 may cause the light source 12 to flash and the alarm device 66 to sound an alarm, thus providing an indication of an alarm condition to the owner of the convenience light 60 and also possibly frightening an intruder. An operator may cancel or acknowledge the alarm condition using the remote control 61

The alarm device 66 may also include a telephone dialer system that, if an appropriate telephone connection, Internet connection, etc. is provided, indicates to an predetermined receiving party (e.g., police department, fire department, security organization) that an intruder or other type of alarm condition has been detected. A variety of motion detectors, intrusion detectors, signaling devices, and the like are available commercially and may be re-packaged and used in the invention.

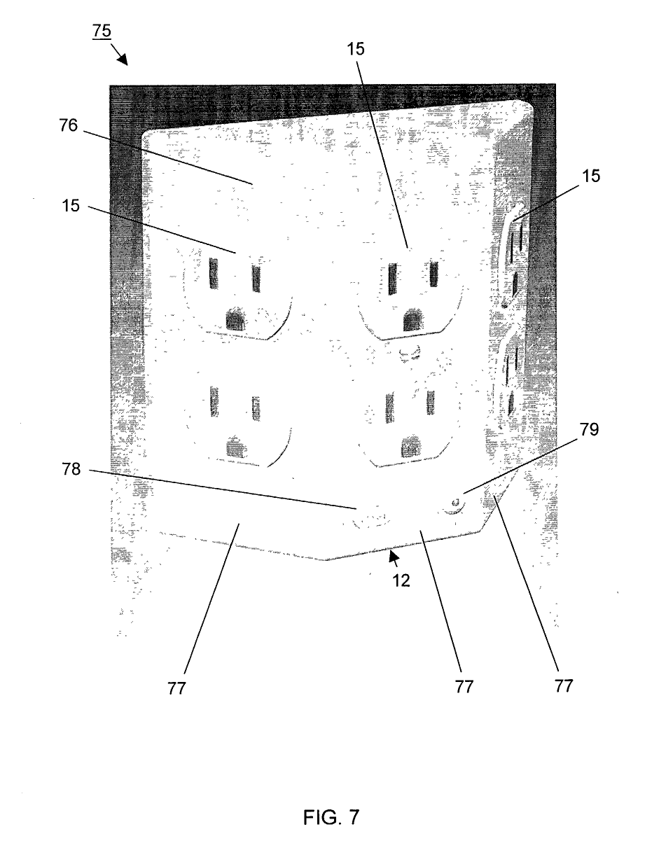

FIG. 7 shows another embodiment of a convenience light 75 according to the present invention. In this embodiment, the convenience light 75 is similar to the embodiments described above and includes a light source 12, multiple supplemental electrical outlets 15, a housing 76, a reset switch 78, and an indicator light 79. As shown, the convenience light 75 includes three supplemental electrical outlets 15. The housing 76 includes three front walls 77 with a supplemental electrical outlet 15 in each front wall

Note that the housing 76 is larger than the housing 13 (FIG. 1) used above in order to provide space to house a conventional surge suppressor for one or more of the electrical outlets 15a, 15b of the respective supplemental electrical outlets 15. As shown, the housing 76 includes three front walls 77 in which the respective supplemental electrical outlets 15 are mounted. In this embodiment, an increased number of supplemental electrical outlets for connection of electrical devices (i.e. more than the two receptacles associated with the conventional electrical outlet 11) For example, three front walls 77 are shown each having a duplex outlet 15, but in various embodiments there may be more or fewer front walls and more or fewer supplemental electrical outlets 15 per front wall. Additionally, since the front walls 77 of the housing 76 are at relatively wide angles to each other, e.g., obtuse angles, respective electrical plugs with large connectors or enclosures (e.g., low voltage transformers) can be plugged into respective receptacles without interfering or bumping into each other.

The interior of the housing 76 may be of a size and shape to accommodate the several supplemental electrical outlets 15 and receptacles of such outlets may be wired together such that the male terminals of one of them are connected to the conventional duplex outlet 11 (described above) to provide power to each receptacle 15a, 15b via a single or via respective surge protectors. As a surge suppressor often has a triggerable circuit that can be reset, there is a reset switch 78 accessible through the front wall 77; and there also is an indicator light 79 to indicate operation of the surge suppressor and/or of the supplemental electrical outlets 15 coupled thereto. If multiple surge suppressors are implemented, there may be an indicator light 79 associated with each surge suppressor.

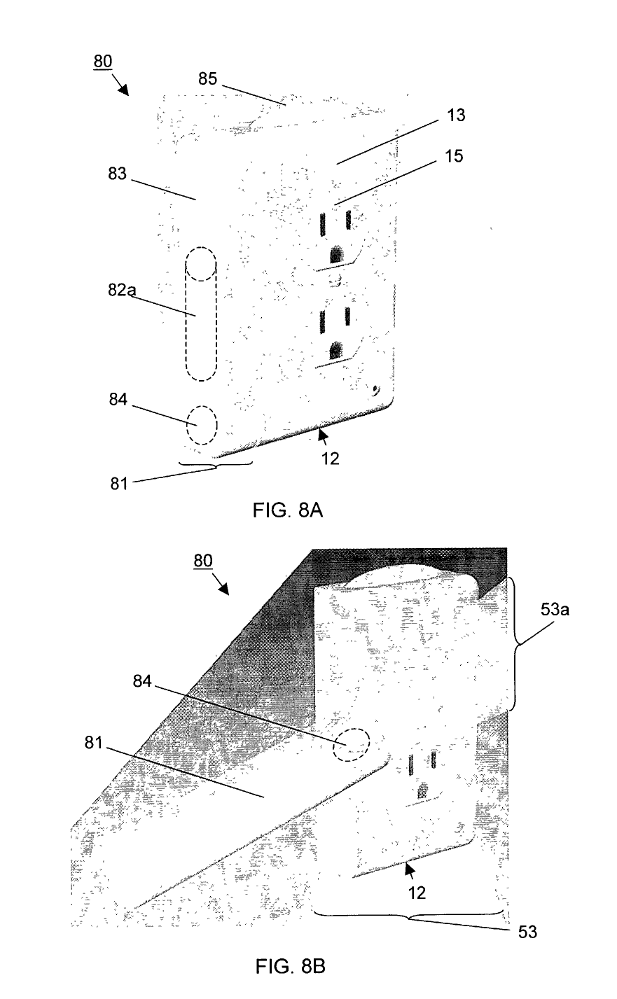

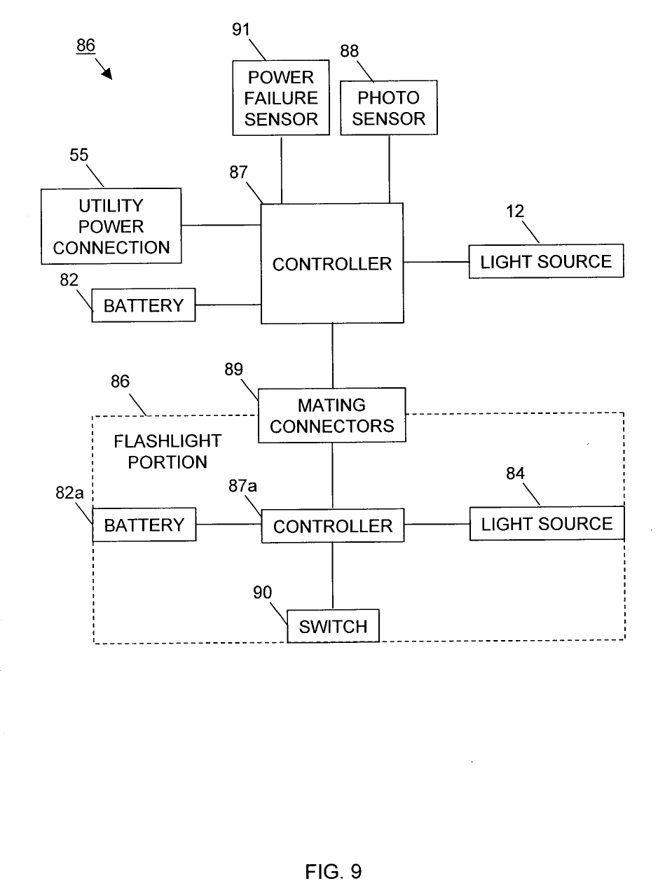

In reference to FIGS. 8A, 8B, and 9, another embodiment of a convenience light 80 is illustrated. In this embodiment, the convenience light 80 is similar to the embodiments described above and includes a light source 12, a housing 13, a supplemental electrical outlet 15, a flashlight portion 81, and a light-transmitting window 85. The flashlight portion 81 includes a battery 82a, a housing 83, and a light source 84. The flashlight portion 81 is connectible and removable from the housing 13 of the convenience light 80. Mating connectors 89 between the flashlight portion 81 and the housing 13 provides electrical power to the flashlight portion when it is connected to the convenience light 80. The battery 82a may be rechargeable or disposable. If the battery is rechargeable, the battery 82a in the housing 83 of the flashlight portion is charged by electrical power from the convenience light 80 routed through the mating connectors 89. The mating connectors 89 are also associated with a control signal to a controller 87a. The control signal may be an identity signal from the controller 87a that is routed through the mating connectors 89 and looped back through the connector in the housing 13 of the convenience light 80. Presence of the control signal indicates to the controller 87a that the flashlight portion 81 is connected to the convenience light 80. Conversely, absence of the control signal indicates that the flashlight portion 81 is removed from the convenience light 80.

Alternatively, the control signal may be routed through a switch 90 that is mechanically activated when the mating connectors 89 are mated. This provides the same type of indications to the controller 87a. When the flashlight portion 81 is removed from the convenience light 80, the controller 87a applies power from the battery 82a to illuminate the light source 84 (e.g., an LED, OLED, ELD, etc.). FIG. 8B depicts the flashlight portion 81 removed from the convenience light 80 showing a light output 53a being emitted from the light source 84.

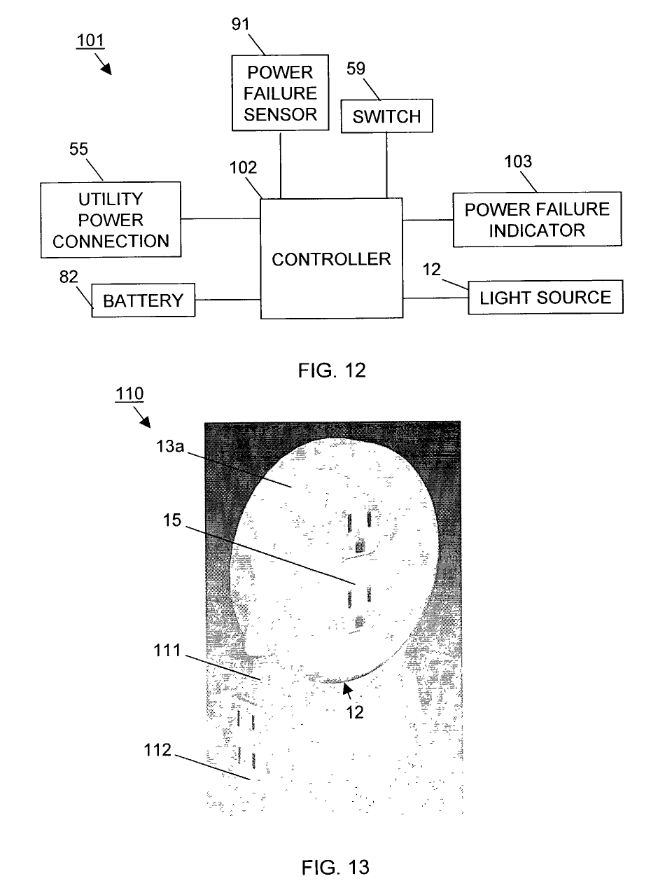

A battery 82 may also be provided in the housing 13 of the convenience light 80 (shown again below with respect to FIG. 12) to power the light source 12 in case of a power failure from the utility power connection 55. This battery 82 may also be rechargeable or disposable. It will be appreciated that rechargeable batteries 82, 82a in the housings 13 and 83 are charged by connection of the convenience light 80 to the conventional duplex outlet 11 (FIG. 2). In conjunction with the battery 82, a power failure sensor 91 in communication with the controller 87 is also provided When the power failure sensor 91 detects a power failure in the electrical power associated with the conventional electrical outlet 11, the controller 87 applies battery power to illuminate light source 12 providing light output 53, as illustrated in FIG. 8B. The controller 87 also isolates the battery 82 from the utility power connection 55 when the power from the conventional electrical outlet 11 is interrupted, as is conventional in battery backup circuitry.

It is also noted that the light-transmitting window 85 in the top of the housing 13 of the convenience light 80 allows the light conditions outside the housing 13 to be detected by a photo sensor 88 in the housing 13; the photo sensor 88 provides an input signal to the controller 87. The controller 87 causes the light source 12 to turn on when it is dark in the ambient area external of the housing 13. Conversely, when the ambient conditions are brighter, unless there is a power failure, the light source 12 is off. For example, FIG. 8A depicts a daytime condition of brightness detected by the photo sensor 88 with the light source 12 off FIG. 8B, for example, depicts the light source 12 turned on in response to a dark condition detected by the photo sensor 88. Both the light-transmitting window 85 and the photo sensor 88 are optional components in the convenience light 80.

FIG. 9 illustrates a circuit 86 associated with the convenience light 80. The circuit 86 includes the batteries 82, 82a, respectively, for the light source 12 in the housing 13 and for the light source 84 in the flashlight portion 81. Respective controllers 87, 87a are associated with respective light sources 12, 84 to turn them on and off, depending on the control signals. The controllers 87, 87a are also used to provide proper charging of the batteries when rechargeable batteries are implemented When the photo sensor 88 option is included, the controller 87 also provides for appropriate routing of utility power or battery power to illuminate the light source 12. Mating connectors 89 (e.g., a plug and socket combination) are used to mechanically and electrically connect and disconnect the flashlight portion 81 from the housing 13 and electrical circuitry (e.g., controller 87) of the convenience light 80. A utility power connection 55 provides electrical power to the circuit 86 for the convenience light 80 including, when connected, the flashlight portion 81. Switch 90 detects when the flashlight portion 86 is removed from the housing 13 (i.e., when the mating connectors are not mated).

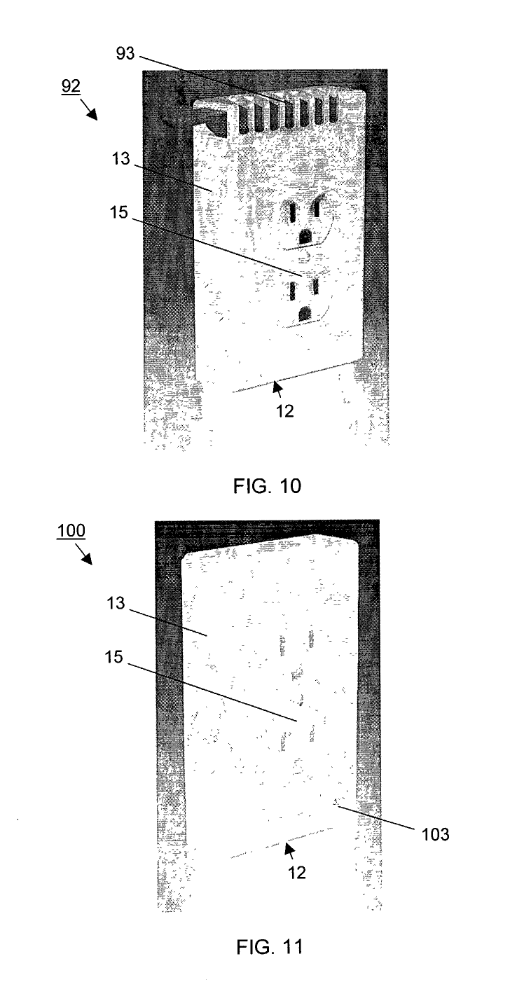

FIG. 10 shows another embodiment of a convenience light 92. In this embodiment, the convenience light 92 is similar to the embodiments described above and includes a light source 12, a housing 13, and a supplemental electrical outlet 15 The housing 13 includes a conventional deodorizer unit 93. Electrically operated deodorizers are commercially available, but they have not incorporated supplemental electrical outlets. Vent openings 94 at the top of the housing 13 allow the deodorant to emanate from the deodorizing unit 93 to provide a pleasant ambient odor in a manner similar to conventional electrically operated deodorizer devices. It will be appreciated that the convenience light 92 provides not only convenience light features and room deodorizer features, but also does so while plugged in to a conventional electrical outlet 11 without reducing the number of electrical outlets available to provide power to other electrical devices, as described above.

FIG. 11 shows another embodiment of a convenience light 100. In this embodiment, the convenience light 100 is similar to the embodiments described above and includes a light source 12, a housing 13, a supplemental electrical outlet 15, and a power failure indicator 103. FIG. 12 shows a circuit 101 associated with the convenience light 100. As shown in the circuit 101, the convenience light 100 also includes a utility power connection 55, a switch 59, a battery 82, a power failure sensor 91, and a controller 102 In this embodiment, the convenience light 101 provides the battery backup function described with respect to FIGS. 8 and 9. The circuit 101 is similar to the circuit 86 (FIG. 9). For example, the power failure sensor 91 is in communication with the controller 102. When the power failure sensor 91 detects a power failure in the electrical power associated with the conventional electrical outlet 11, the controller 102 applies battery power to illuminate light source 12. The controller 102 also isolates the battery 82 from the utility power connection 55 when the power from the conventional electrical outlet 11 is interrupted, as is conventional in battery backup circuitry. Additionally, the circuit 101 includes the power failure indicator 103 which is illuminated by the controller 102 when a failure of the primary input power is sensed. The power failure indicator 103 is shown in the front wall of the housing 13.

FIG. 13 shows another embodiment of a convenience light 110. In this embodiment, the convenience light 110 is similar to the embodiments described above and includes a light source 12, a housing 13a, and a supplemental electrical outlet 15. However, this embodiment also includes an extension cord, and an internal reel storage mechanism. The extension cord includes an electrical cord 111 with an electrical outlet portion 112 attached to an end of the cord. The housing 13a has space for the internal reel, on which the electrical cord 111 is wound for storage. The electrical outlet portion 112 includes one or more electrical receptacles, each of which may be used to provide electrical power from the conventional electrical outlet 11 via power connections in the housing 13a The extension cord permits the electrical power to be extended up to the length of the electrical cord 111 from the conventional electrical outlet 11. A person pulls the extension cord to unwind the electrical cord 111 from the storage wheel to a desired distance. The storage wheel can lock in place when the person stops pulling. If the person wants the cord to be wound back on the storage reel, a pull and a release of tension can unlock the storage reel and cause the electrical cord 111 to be retracted. In another embodiment, a button (not illustrated) could be provided on the housing 13a to unlock the reel and retract the electrical cord 111.

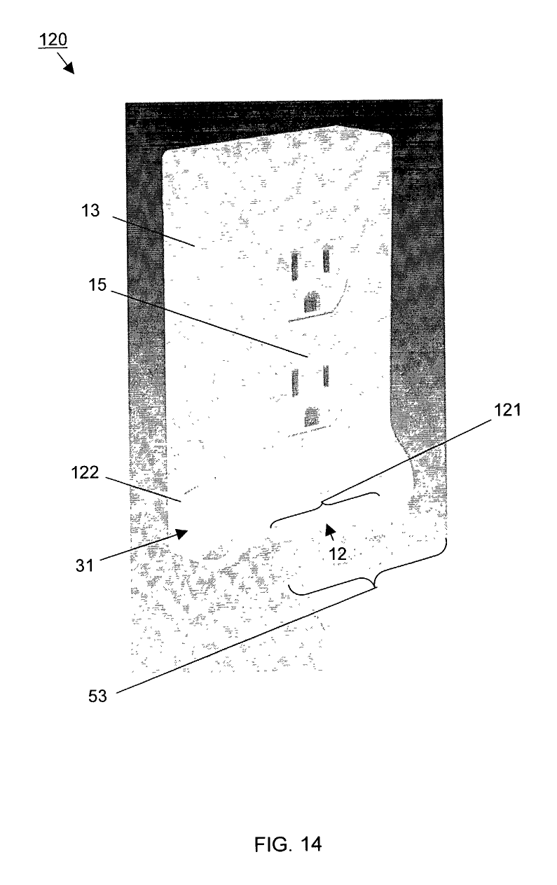

FIG. 14 shows another embodiment of a convenience light 120 In this embodiment, the convenience light 120 is similar to the embodiments described above and includes a light source 12, a housing 13, a supplemental electrical outlet 15, and a cylindrical insert 31. The cylindrical insert includes a slot 121 and a handle 122 Light output 53 from the light source 12 is directed through the slot 121. The handle 122 is used to move the cylindrical insert along a rotational path to adjust the direction of the light output 53. The housing 13 has a space for locating the cylindrical insert 31 in relation to the light source 12 so that movement of the cylindrical insert 31 changes the direction of light output 53 from the light source 12.

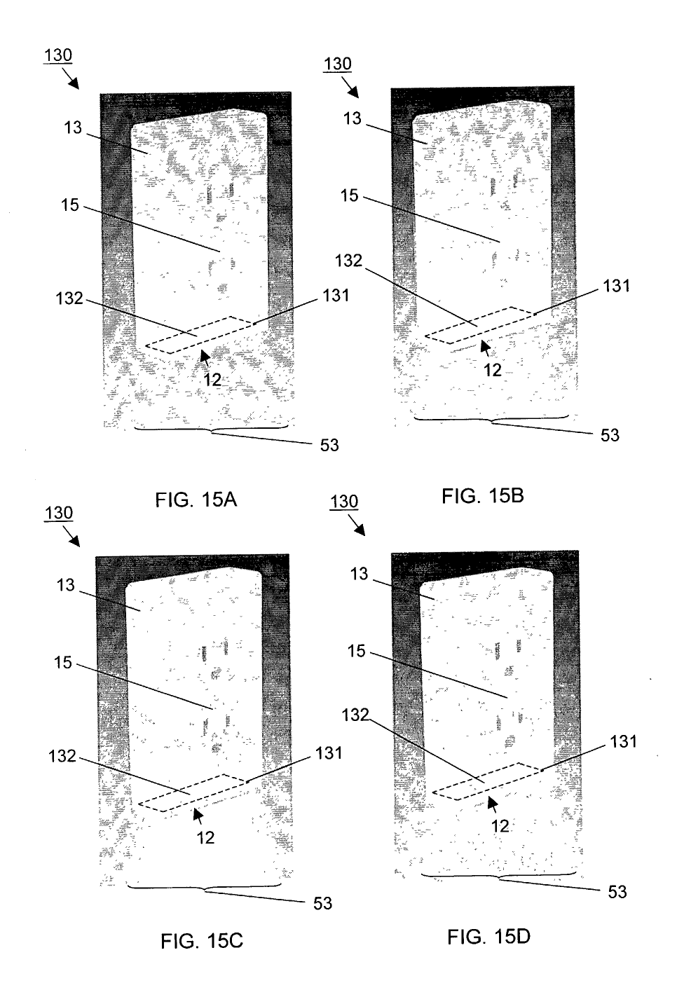

FIGS. 15A-D show alternate embodiments of another convenience light 130 according to the present invention. In this embodiment, the convenience light 130 is similar to the embodiments described above and includes a light source 12, a housing 13, and a supplemental electrical outlet 15. The housing 13 includes an opening 131 through which light output 53 from the light source 12 is directed. The opening 131 receives an insert 132 which has an effect on the light output 53. Various inserts can be used in the convenience light to create different light output effects. Typically, the opening 131 and the insert 132 are elongated along the length of a bottom wall of the housing.

FIG. 15A, for example, shows the convenience light 130 with an insert that partially blocks the light output 53 resulting in a minimal light output effect. In this embodiment, the insert may resemble a grid or screen with limited openings.

FIG. 15B, for example, shows the convenience light 130 with an insert that filters and blends the light output 53 resulting in a normal light output effect. In this embodiment, the insert may be a frosted or colored lens.

FIG. 15C, for example, shows the convenience light 130 with an insert that has virtually no effect on the light output 53 resulting in a full intensity output effect. In this embodiment, the insert may be a clear lens.

FIG. 15D, for example, shows the convenience light 130 with an insert that diffuses the light output 53 resulting in a diffused output effect. In this embodiment, the insert is a diffuser.

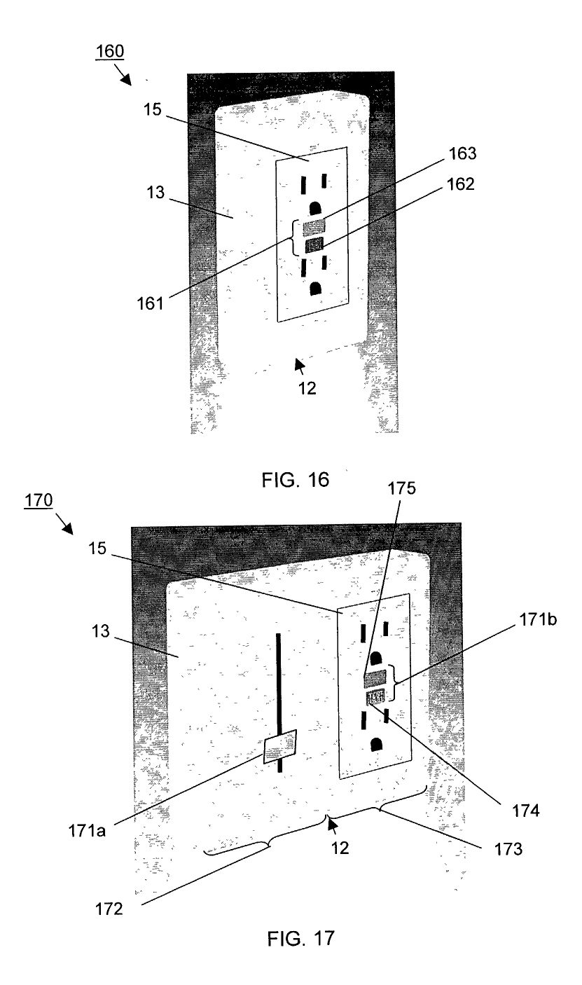

FIG. 16 shows another embodiment of a convenience light 160 In this embodiment, the convenience light 160 is similar to the embodiments described above and includes a light source 12, a housing 13, a supplemental electrical outlet 15, but it also includes pass-through controls 161 to operate a ground fault circuit interrupter (GFCI) electrical outlet to which the convenience light is coupled. The pass-through controls 161 include a test button 162 and a reset button 163. The pass-through controls 161 are positioned in relation to test and reset buttons on the GFCI electrical outlet. The pass-through controls 161 are mechanically extended through the housing 13 so that activation of the test button 162 depresses the test button on the GFCI electrical outlet to which the convenience light is coupled. Likewise, activation of the reset button 163 causes an associated mechanical linkage to depress the reset button on the GFCI electrical outlet.

In another embodiment, the supplemental electrical outlet 15 is a functional GFCI outlet. This allows the convenience light 160 to provide standard GFCI features when coupled to a conventional electrical outlet 11. In this embodiment, the test button 162 and the reset button 163 control the supplemental GFCI outlet in the same manner as like controls in a conventional GFCI outlet.

FIG. 17 shows another embodiment of a convenience light 170 according to the present invention. In this embodiment, the convenience light 170 is similar to the embodiments described above and includes a light source 12, a housing 13, a supplemental electrical outlet 15 However, it also includes pass-through controls 171a, 171b to operate a toggle switch and a GFCI electrical outlet to which the convenience light is coupled. The housing 13 includes a switch portion 172 and a supplemental electrical outlet portion 173. The pass-through controls 171b to operate the GFCI electrical outlet are located in the supplemental electrical outlet portion 173 These pass-through controls 171b include a test button 174 and a reset button 175 which are positioned and operate in the same manner as described above for FIG. 16. The GFCI pass-through controls 171b are optional in this embodiment. Additionally, the supplemental electrical outlet 15 in this embodiment may be a supplemental GFCI outlet as described above for FIG. 16.

The pass-through control 171a to operate the toggle switch is located in the toggle switch portion 172. This pass-through control 171a has the appearance of a slide switch and is positioned in relation to a conventional toggle switch that is ganged together with the GFCI electrical outlet to which the convenience light 170 is coupled. Within the housing, the slide switch is mechanically linked to a sliding block with an elongated recessed area that receives a bat associated with the conventional toggle switch. The sliding block and the elongated recessed area are positioned so that moving the slide switch up to a first position causes the block to flip the bat of the toggle switch up. Similarly, moving the slide switch down to a second position causes the block to flip the bat of the toggle switch down. The conventional toggle switch can be a single pole, three-way, or four-way switch

In an alternate embodiment, the toggle switch portion can simply provide an opening positioned in relation to the conventional toggle switch. The opening provides persons with access to operate the conventional toggle switch in the usual manner.

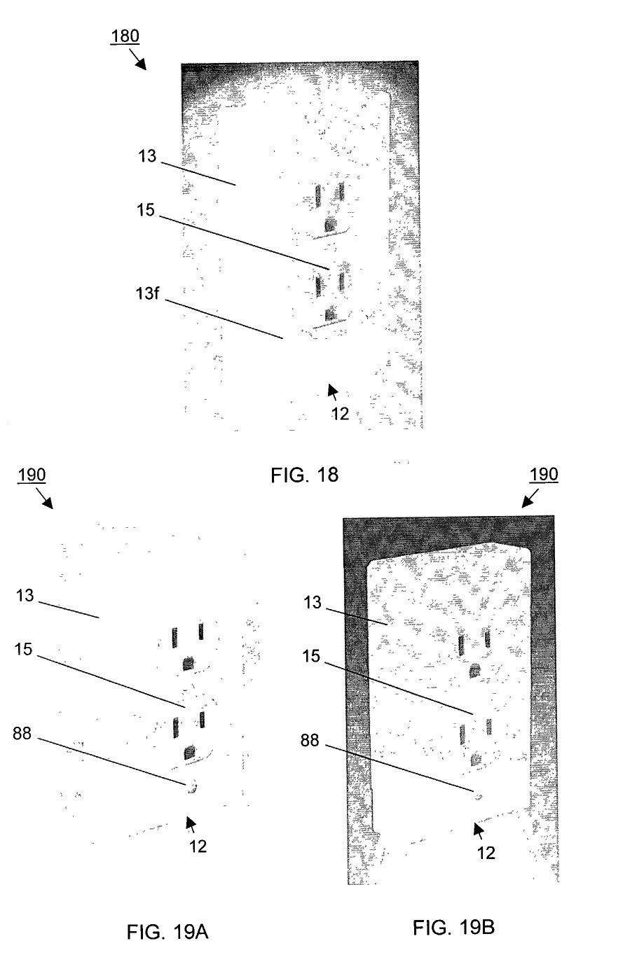

FIG. 18 shows another embodiment of a convenience light 180. In this embodiment, the convenience light 180 is similar to the embodiments described above and includes a light source 12, a housing 13, a supplemental electrical outlet 15, but it includes a glowing cover 13f.

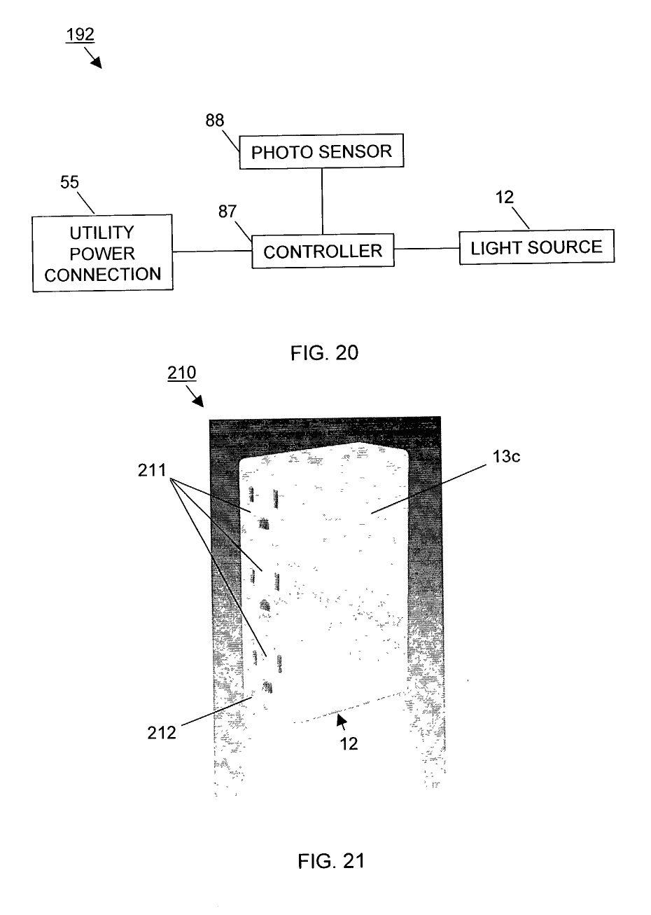

FIGS. 19A and 19B show another embodiment of a convenience light 190. In this embodiment, the convenience light 190 is similar to the embodiments described above and includes a light source 12, a housing 13, a supplemental electrical outlet 15, but also includes a photo sensor 88. FIG. 20 shows a circuit 192 associated with the convenience light 190. Operation of the circuit 192 is generally as described for the photo sensor controlled portion of the convenience light 80 of FIGS. 8 and 9. The circuit 192 includes a utility power connection 55, a controller 87, the photo sensor 88, and the light source 12.

FIG. 21 shows another embodiment of a convenience light 210 according to the present invention. In this embodiment, the convenience light 210 is similar to the embodiments described above and includes a light source 12 and a housing 13c. The housing 13c includes multiple electrical receptacles 211 in sidewalls 212. FIG. 21 shows three receptacles 211 in a left sidewall 211 of the housing. In other embodiments, receptacles 212 can be located in the left sidewall, right sidewall, upper sidewall, or lower sidewall in various amounts and in any combination. The construction of this convenience light 210 allows plugs to be inserted parallel to a wall so they do not stick out perpendicularly into a room.

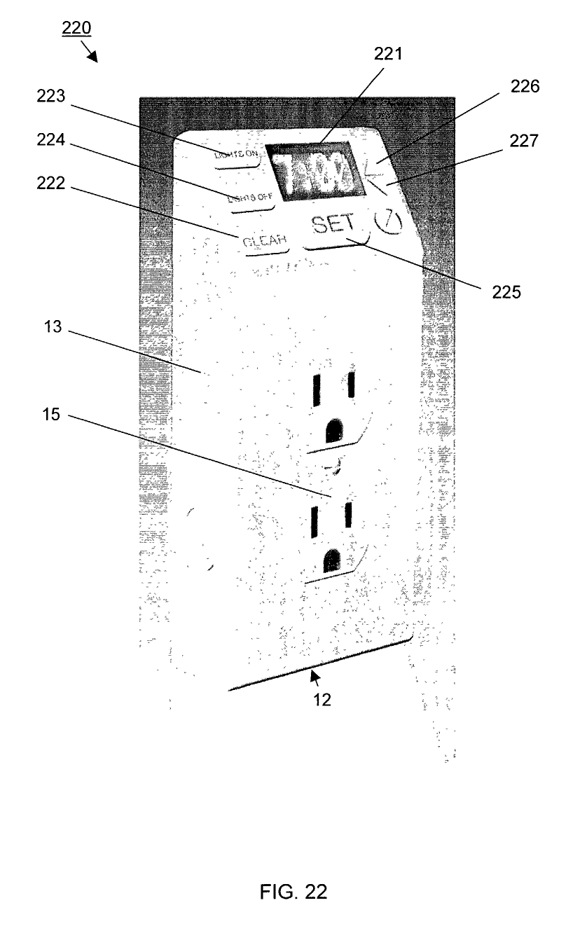

FIG. 22 shows another embodiment of a convenience light 220 In this embodiment, the convenience light 220 is similar to the embodiments described above and includes a light source 12, a housing 13, a supplemental electrical outlet 15, but also includes a timer The timer determines when power from the conventional electrical outlet 11 is applied and removed from the supplemental electrical outlet 15. The circuitry 14 (FIG. 1) within the housing includes components that make up the timer. These components include a display 221, a CLEAR switch 222, an ON switch 223, an OFF switch 224, a SET switch 225, an “up arrow” or increase switch 226 , a “down arrow” or decrease switch 227, and a timer controller.

The timer controller includes a day clock and is in communication with the display 221, CLEAR switch 222, ON switch 223, OFF switch 224, SET switch 225, increase switch 226, and decrease switch 227. The display 221 normally displays the time of day. To set the day clock, a person presses and holds the SET switch 225 and presses the increase or decrease switch 226, 227 until the desired time is displayed on the display 221. When the desired time is displayed, the person releases the SET switch 225. In another embodiment, the user may press and release the SET switch 225 both before and after setting the clock to the desired time. In still another embodiment, the timer may include a one week clock or a selected interval of days clock. In yet another embodiment, the increase and decrease switches 226, 227 may be replaced by more or less switches (e.g., one switch) that accomplishes the same functions.

Next, the person sets a time when the convenience light 220 will apply power to the supplement electrical outlet 15. The person presses and holds the ON switch 223 and presses the increase or decrease switch 226, 227 until a time that the supplemental electrical outlet 15 is desired to receive power is displayed on the display 221. When the desired time is displayed, the person releases the ON switch 223. In another embodiment, the user may press and release the ON switch 223 both before and after setting the desired time.

Next, the person may set a time when the convenience light 220 will remove power from the supplement electrical outlet 15. The person presses and holds the OFF switch 224 and presses the increase or decrease switch 226, 227 until a time at which power is desired to be removed from the supplemental electrical outlet 15 is displayed on the display 221. When the desired time is displayed, the person releases the OFF switch 224. In another embodiment, the user may press and release the OFF switch 224 both before and after setting the desired time. The person may press the CLEAR switch 222 to cancel all set times for power to be applied and removed from the supplemental electrical outlet 15.

If a time to apply power is set, but a time to remove power is not set, power will remain applied to the supplemental electrical outlet 15. Otherwise, if times are set to both apply and remove power, the convenience outlet 220 typically applies power and removes power each day at the set times. In other embodiment, day of the week or incremental days can be associated with the set times. In still another embodiment, multiple ON and OFF times can be set for a given day. In yet another embodiment, multiple ON and OFF times can be set for a week or for a selected interval of days.

While the invention has been described herein in conjunction with numerous exemplary embodiments, it is evident that many alternatives, modifications, and variations will be apparent to those skilled in the art. For example, any combination special features identified in the various embodiments described above are possible. For example, the pass-through GFCI controls (FIG. 16) could be combined with the timer (FIG. 22). Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

What is claimed is:

1. An apparatus for insertion in an associated conventional electrical outlet having one or more electrical receptacles, including:
a housing;
a first light source disposed within the housing to emit light from the apparatus when the apparatus is inserted in the associated conventional electrical outlet; and
a supplemental electrical outlet disposed within the housing and having at least the same amount of electrical receptacles as the associated conventional electrical outlet to provide access to electrical power provided by the associated conventional electrical outlet when the apparatus is inserted therein.

2. The apparatus as set forth in claim 1, further including:
a sensor to detect an alarm condition;
an alarm device to indicate that an alarm condition was detected;
a controller in communication with the sensor and the alarm device to activate the alarm device after the alarm condition was detected; and
a cancel switch device in communication with the controller whereby an operator can acknowledge that the alarm indication has been recognized.

3. The apparatus as set forth in claim 2 wherein the sensor includes at least one sensor selected from the group of a motion detector, a heat sensor, a smoke detector, and a carbon monoxide detector.

4. The apparatus as set forth in claim 2 wherein the alarm device emits an audible tone to indicate that an alarm condition exists.

5. The apparatus as set forth in claim 2 wherein the alarm device includes a telephone dialer system and places a telephone call to a predetermined receiving party to indicate that an alarm condition exists.

6. The apparatus as set forth in claim 2 wherein the controller is also in communication with the light source and flashes the light source after the alarm condition is detected by the sensor.

7. The apparatus as set forth in claim 2 wherein the cancel switch device is part of a wireless remote control.

8. The apparatus as set forth in claim 7, the wireless remote control further including:
a set switch device in communication with the controller whereby an operator can manually communicate an alarm condition to the controller.

9. The apparatus as set forth in claim 1, wherein the supplemental electrical outlet has more electrical receptacles than the associated conventional electrical outlet into which the apparatus is inserted

10. The apparatus as set forth in claim 9, wherein the electrical receptacles of the supplemental electrical outlet are arranged on one or more front walls of the housing.

11. The apparatus as set forth in claim 9, wherein the electrical receptacles of the supplemental electrical outlet are arranged on one or more side walls of the housing.

12. The apparatus as set forth in claim 9, further including:
at least one surge suppression device associated with the supplemental electrical outlet.

13. The apparatus as set forth in claim 9, further including:
a surge suppression device for each electrical receptacle of the supplemental electrical outlet

14. The apparatus as set forth in claim 1, further including:
a removable flashlight portion; and
mating connectors, including a housing connector associated with the housing and a flashlight connector associated with the flashlight portion.

15. The apparatus as set forth in claim 14, the removable flashlight portion further including:
a battery;
a second light source; and
a controller in communication with the battery, the second light source, and the flashlight connector, wherein the controller routes electrical power from the battery to the second light source when the connectors are not mated.

16. The apparatus as set forth in claim 15, wherein the battery is a rechargeable battery, wherein the housing connector is in communication with the electrical power associated with the conventional electrical outlet when the apparatus is inserted therein, wherein the controller routes electrical power associated with the conventional electrical outlet to the rechargeable battery when the mating connectors are mated.

17. The apparatus as set forth in claim 1, further including:
a deodorizer unit

18. The apparatus as set forth in claim 1, further including:
a reel storage mechanism associated with the housing; and
a retractable extension cord to provide extended access to electrical power associated with the conventional electrical outlet when the apparatus is inserted therein.

19. The apparatus as set forth in claim 1, further including:
an insert disposed in an opening of the housing in relation to the first light source, wherein light output from the light source is directed through the insert.

20. The apparatus as set forth in claim 19, wherein the insert is a generally cylindrical in shape and includes a handle to enable rotation of the insert to adjust the direction of the light output.

21. The apparatus as set forth in claim 20, wherein the generally cylindrical insert includes a solid wall portion and an open portion.

22. The apparatus as set forth in claim 21, wherein the solid wall portion includes a light diffusing sub-portion and a light attenuating sub-portion.

23. The apparatus as set forth in claim 19, wherein the insert is a generally elongated insert that has an effect on the light output, wherein the effect is selected from the group of a minimal light output effect, a normal light output effect, a full intensity light output effect, and a diffused light output effect.

24. The apparatus as set forth in claim 1, wherein the conventional electrical outlet is a ground fault circuit interrupter (GFCI) outlet, the apparatus further including:
pass-through GFCI controls extending through the housing to mechanically operate control buttons on the GFCI outlet.

25. The apparatus as set forth in claim 1, wherein the GFCI outlet is adjacent to a conventional toggle switch, the housing further including:
a toggle switch portion adjacent to the supplemental electrical outlet and positioned in relation to the conventional toggle switch.

26. The apparatus as set forth in claim 25, the toggle switch portion of the housing further including:
a pass-through toggle switch control movable between a first position and a second position and adapted to receive a bat associated with the conventional toggle switch in an elongated recessed area of the pass-through toggle switch control when the apparatus is inserted in the conventional electrical outlet, wherein movement of the pass-through toggle switch control from the first position to the second position and vice versa causes the conventional toggle switch to toggle

27. The apparatus as set forth in claim 1, further including:
a glowing cover adapted to over at least a front side of the housing with at least one opening to fit over the supplemental electrical outlet.

28. An apparatus for insertion into an associated conventional electrical outlet having one or more electrical receptacles, including:
a housing;
a first light source disposed within the housing to selectively emit light from the apparatus when the apparatus is inserted in the associated conventional electrical outlet;
a supplemental electrical outlet disposed within the housing and having at least the same amount of electrical receptacles as the associated conventional electrical outlet to allow access to electrical power provided by the associated conventional electrical outlet when the apparatus is inserted therein; and
a control device to control when the light source emits light.

29. The apparatus as set forth in claim 28, wherein the control device is a voice-activated control device.

30. The apparatus as set forth in claim 29, the control device further including:
a sound sensor;
a voice recognition device in communication with the sound sensor to detect audible commands to illuminate and audible commands to extinguish the light source; and
a controller in communication with the voice recognition device to illuminate and extinguish the light source in response to detection of associated audible commands by the voice recognition device

31. The apparatus as set forth in claim 28, wherein the control device is a manually-operated switch having at least two positions, wherein a first position causes the light to be illuminated and a second position causes the light to be extinguished.

32. The apparatus as set forth in claim 28, wherein the control device is a power failure sensor in communication with the electrical power associated with the conventional electrical outlet, the apparatus further including;
a battery; and
a first controller in communication with the power failure sensor and the battery to illuminate the light source using electrical power from the battery in response to detection of a power failure regarding the electrical power associated with the conventional electrical outlet when the apparatus is inserted therein.

33. The apparatus as set forth in claim 32, wherein the battery is a rechargeable battery and the first controller routes electrical power associated with the conventional electrical outlet to charge the battery when the apparatus is inserted in the conventional electrical outlet.

34. The apparatus as set forth in claim 33, further including:
a removable flashlight portion, and
mating connectors, including a housing connector associated with the housing and a flashlight connector associated with the flashlight portion.

35. The apparatus as set forth in claim 34, the removable flashlight portion further including:
a battery,
a second light source; and
a second controller in communication with the battery, the second light source, and the flashlight connector, wherein the second controller routes electrical power from the battery to the second light source when the connectors are not mated.

36. The apparatus as set forth in claim 35, wherein the battery is a rechargeable battery, wherein the housing connector is in communication with the electrical power associated with the conventional electrical outlet when the apparatus is inserted therein, wherein the second controller routes electrical power associated with the conventional electrical outlet to the rechargeable battery when the mating connectors are mated.

37. The apparatus as set forth in claim 28, wherein the control device is a light sensor for detecting ambient lighting conditions in the environment surrounding the apparatus, the apparatus further including;
a controller in communication with the light sensor to illuminate the light source in response to detection of a generally dark ambient lighting condition when the apparatus is inserted in the conventional electrical outlet.

38. An apparatus for insertion into an associated conventional electrical outlet having one or more electrical receptacles, including:
a housing;
a first light source disposed within the housing to emit light from the apparatus when the apparatus is inserted in the conventional electrical outlet;
a supplemental electrical outlet disposed within the housing and having at least the same amount of electrical receptacles as the associated conventional electrical outlet to selectively allow access to electrical power provided by the conventional electrical outlet when the apparatus is inserted therein; and
a control device to control when the supplemental electrical outlet provides access to the electrical power

39. The apparatus as set forth in claim 38, wherein the control device is a voice-activated control device

40. The apparatus as set forth in claim 39, the control device further including:
a sound sensor;
a voice recognition device in communication with the sound sensor to detect audible commands to apply the electrical power to the supplemental electrical outlet and audible commands to remove the electrical power from the supplemental electrical outlet; and
a controller in communication with the voice recognition device to apply and remove the electrical power respectively to and from the supplemental electrical outlet in response to detection of associated audible commands by the voice recognition device.

41. The apparatus as set forth in claim 38, wherein the control device is a timer.

42. The apparatus as set forth in claim 41, the control device further including:
a display to display a time;
a first switch associated with selection of a first time corresponding to a time of day;
a second switch associated with selection of a second time at which the electrical power is applied to the supplemental electrical outlet;
a third switch associated with selection of a third time at which the electrical power is removed from the supplemental electrical outlet;
at least one additional switch to adjust the time displayed on the display;
a timer controller in communication with the display, the first switch, the second switch, the third switch, and each additional switch to maintain the first time, to apply electrical power to the supplemental electrical outlet when the second time matches the first time, and to remove electrical power from the supplemental electrical outlet when the third time matches the first time.

43. A lighted plug-in device comprising:
a housing;
a supplemental electrical outlet supported by said housing and adapted for insertion into an associated conventional electrical outlet;
a light source supported by said housing;
a circuit board supported by said housing and communicating with said light source for regulating a flow of electricity to said light source; and
a power line communicating said circuit board with a source of electrical power held by said housing.

44. The plug-in device of claim 43 wherein said source of electrical power held by said housing comprises an internal socket and said power line terminates in a pin insertable in said internal socket.

45. The plug-in device of claim 43 wherein said housing comprises;
a back cover; and
a front cover secured to said back cover.

46. The plug-in device of claim 45 further comprising a first fastener for securing said back cover to said front cover.

47. The plug-in device of claim 46 further comprising a second fastener for securing said supplemental electrical outlet to said front cover.

48. The outlet of claim 45 wherein said circuit board is mounted in said rear housing and wherein said light source comprises a second circuit board which is mounted in said rear housing.

49. The plug-in device of claim 43 further comprising a light directing element mounted to said housing for guiding a light output of said light source in a desired direction.

50. The plug-in device of claim 49 wherein said light directing element is movable in relation to said housing.

51. The plug-in device of claim 50 wherein said light directing element comprises an open wall portion and a solid wall portion.

52. The plug-in device of claims 43 wherein said light source comprises at least one light emitting diode.
